(19) United States
(12) Patent Application Publication
(10) Pub. No.: US 2009/0119349 A1
(43) Pub. Date: May 7, 2009

(54) Methods and Computer Program Products for Efficient Conflict Detection in a Replicated Hierarchical Content Repository Using Replication Anchors

(75) Inventors: Stefan B. Edlund, San Jose, CA (US); Hui-I Hsiao, Saratoga, CA (US); Joshua W. Hui, San Jose, CA (US)

Correspondence Address: CANTOR COLBURN, LLP - IBM ARC DIVISION, 20 Church Street, 22nd Floor, Hartford, CT, 06103, US

(73) Assignee: International Business Machines Corporation, Armonk, NY (US)

(21) Appl. No.: 11/936,602

(22) Filed: Nov. 7, 2007

(51) Int. Cl. G06F 17/30

(52) U.S. Cl. 707/203; 707/E17.005

(57) ABSTRACT

Exemplary embodiments of the present invention relate to a methodology for using replication anchors to detect conflicts within replicated hierarchical content repository. The method comprises locking a data object in the event that an operation applied on the data object is replicated from a first server to a second server, reading a transaction identifier that is associated with the data object, retrieving a transaction sequence value that is associated with the transaction identifier, and determining if a conflict situation exist by comparing the retrieved transaction sequence value with an operation synchronization anchor value, the operation synchronization value being the transaction sequence value of a last transaction from the second server to the first server, wherein a conflict situation is determined to exist in the event that the transaction sequence value is greater than the operation synchronization anchor value.

### BACKGROUND OF THE INVENTION

1. Field of the Invention

This invention relates to data replication operations and particularly to conflict detection in replicated hierarchical data content by the use of data replication anchors.

2. Description of Background

In general, content replication can be performed among a small set of servers or between a server and a large set of clients. In both cases content replication can be either unidirectional or bidirectional. In the former case, content can only be updated at a single server and thereafter the content updates are propagated to the read-only replication systems. In the latter case, content can be updated in any replication systems, thus resulting in the possibility of operational conflicts arising between updating actions that have been performed at differing replication systems. In the server-to-server replication case, content repositories are hosted on servers and content replication occurs between servers. In the client-to-server case, content is stored at the server and subsets of content are replicated at different clients. Client-server replication is very important for mobile clients where clients can disconnect from network regularly.

### SUMMARY OF THE INVENTION

The shortcomings of the prior art are overcome and additional advantages are provided through the provision of a method for using replication anchors to detect conflicts within replicated hierarchical content repository. The method comprises locking a data object in the event that an operation applied on the data object is replicated from a first server to a second server, reading a transaction identifier that is associated with the data object, retrieving a transaction sequence value that is associated with the transaction identifier, and determining if a conflict situation exist by comparing the retrieved transaction sequence value with an operation synchronization anchor value, the operation synchronization value being the transaction sequence value of a last transaction from the second server to the first server, wherein a conflict situation is determined to exist in the event that the transaction sequence value is greater than the operation synchronization anchor value.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawing.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a flow diagram illustrating an exemplary method for detecting conflicts within replicated hierarchical content.

FIG. 2 illustrates an example of a diagram illustrating a method of detecting conflicts within replicated hierarchical data object content by the use of replication anchors in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Aspects of the exemplary embodiment of the present invention can be implemented within a conventional computing system environment comprising hardware and software elements. Specifically, the methodologies of the present invention can be implemented to program a conventional computer system in order to accomplish the prescribed tasks of the present invention as described below.

Within exemplary embodiments of the present invention the problem of detecting conflicts in a bidirectional replicated hierarchical content repository is considered and a solution for efficiently determining whether a conflict exist during a locking/conflict detection phase just before applying an operation is presented. Specifically, a content repository is organized in a hierarchical tree wherein the nodes have properties, and further, links between the nodes form a tree—no hard-links are utilized, that is every node except the root node has a single parent. The repository maps to a content repository (e.g., a JSR-170 (JCR) content repository, wherein the XML document repository is a specialized hierarchical content repository where each XML document is a hierarchical tree).

Examples of conflicts that are considered within the exemplary embodiments of the present invention include the following conflicts:
Update/Update Conflict—Is an event where a node is updated in on server 1 and replicated to server 2 where the node has also been updated.
Update/Delete Conflict—Is an event where a node is updated on server 1 and replicated to server 2 where the node has been deleted.
Delete/Update Conflict—Is an event where a node A is deleted on server 1 and replicated to server 2 where the node A has been updated. A Delete/Update conflict also exists if any of the children under node A on server 2 have been updated—since the children will be recursively deleted upon the deletion of node A.

Additional conflicts can comprise further operations such as move, rename, etc. Within the exemplary embodiments the information that is exchanged between two replicas is minimized, while still providing the capability to detect a conflict situation. In particular, there is no need to maintain an update history for individual nodes.

Within the exemplary embodiments of the present invention it is assumed that each operation that modifies any piece of content takes place in the context of a transaction. As such, each transaction will have a unique identifier that is associated with a respective transaction. It is further assumed that transactions can be ordered in their commit order. Thus, it is possible to associate a transaction with a monotonically increasing sequence number (i.e., the commit number). At a transaction commit time, the current sequence number is incremented by one and assigned to the transaction.

In operation, transaction sequence values serve as a replication anchors, wherein each server (or client) retains a replication anchor that represents the last transaction sequence that was transmitted to a particular server (or client). When updates (or actions) of multiple transactions are transmitted in a single replication request, the largest transaction sequence of the set is set as the replication anchor. For example, a Server 1 will keep a replication anchor value LASTANCHOR (2) with the transaction sequence value for the last transaction that was sent from Server 1 to a Server 2. Conversely, Server 2 will save the opposite replication anchor value LASTANCHOR (1) with the transaction sequence value for the last transaction that was sent from server 2 to server 1. Within further exemplary embodiments of the present invention nodes (i.e., units of replication in JCR) in the content repository are annotated to indicate the last transaction identifier that updated—or deleted—the nodes. Thus, stubs for deleted nodes are retained for replication purposes.

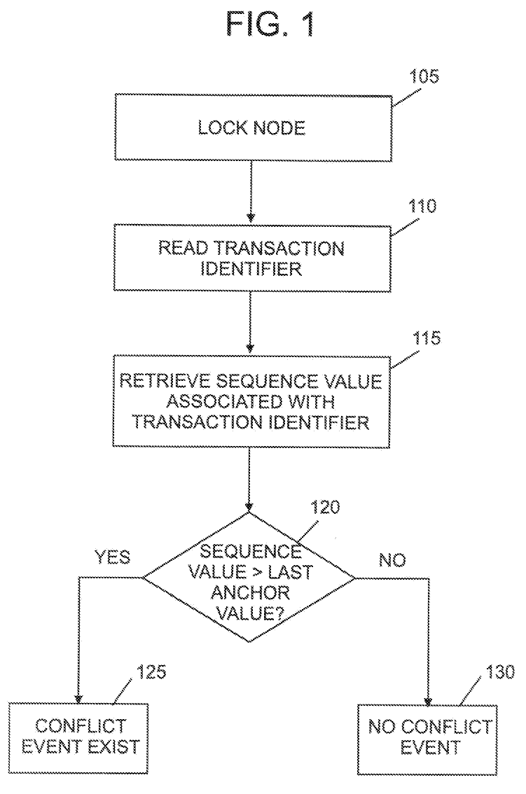

FIG. 1 shows a flow diagram illustrating an exemplary method for detecting conflicts within replicated hierarchical content. At step 105, when an operation applied on a node N is replicated from a first server to a second server the second server locks the node N. At step 110 and the second server reads the transaction identifier of the node N. Next, at step 115, the second server fetches the corresponding transaction sequence value for the transaction identifier. At step 120 a determination is made to if the transaction sequence value is greater than the value of the last replication anchor value. If it is determined that the transaction sequence value is greater than the last replication anchor value for operations send from the second server to the first server, then a conflict situation exists (step 125). If it is determined that the transaction the transaction sequence number is less than or equal to the last replication anchor value then no conflict exist (step 130).

The solution of the exemplary embodiments of the present invention is particularly useful for the detection of Delete/Update conflicts since there is no need to propagate any versioning information for a whole sub-tree in order to detect such conflicts. The present solution only keeps track the replication anchor value (which is an integer) for each partner node. Unlike the known solutions, the present solution does not maintain or communicate the before value of an updated node nor does it require to maintain the lineage information of a node.

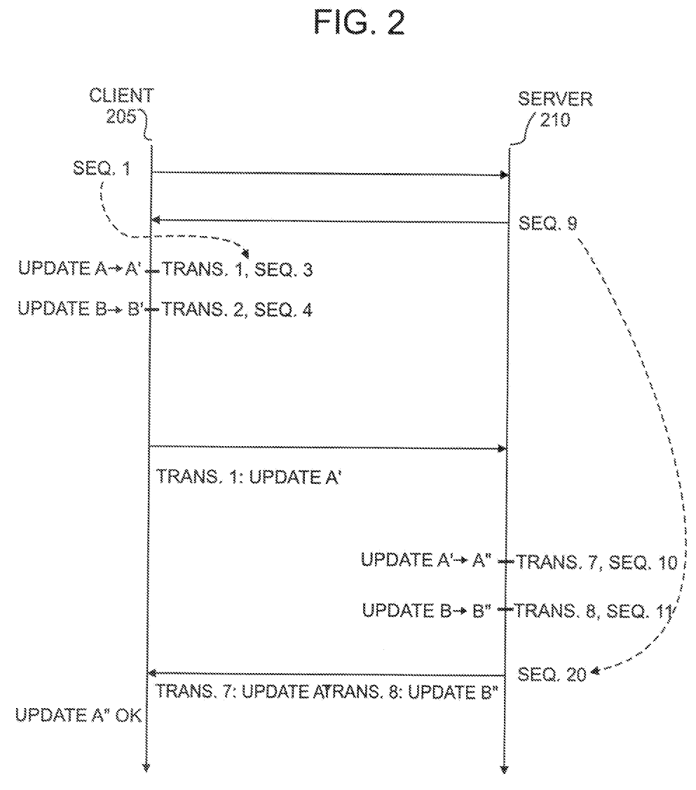

FIG. 2 illustrates an example of a diagram illustrating a method of detecting conflicts within replicated hierarchical data object content by the use of replication anchors. As shown in FIG. 2, a client 205 changes are replicated to a server 210. From perspective of the client 205, the last synchronization anchor value with the server that is associated with the initial transaction is Seq. 1. The server 210 replicates its changes back to the client 205. From the server's 210 perspective the last synchronization anchor value associated with the transaction to the client 205 is Seq. 9.

As shown, there are two operations occurring at the client 205. The first operation is an Update A operation within transaction 1 that is associated with Seq. 3 and the Update B operation within transaction 2 that is associated with Seq. 4. Next, the client 205 attempts to data object changes back to the server 205. The changes are divided into two segments. The first data segment contains Trans. 1: Update A′ and the other segment contains Trans. 2: Update B′. However, the communication from the client 205 to the server 210 is lost in transmission. Thus, only the first transmitted segment was able to be replicated at the server 210, thus the last synchronization anchor value stored at the client 205 is now Seq. 3 instead of Seq. 1.

Two operations occur at the server 210, the operations being an Update A″ operation within transaction 7 and an Update B″ operation within transaction 8. When the server 210 replicates changes to the client 205, the following situations are detected. At the client 205 the Update A″ operation is determined to be valid because the original image A′ at the client 205 is associated with a transaction value that is equal to the last synchronization anchor value at the client, which is Seq. 3. However, the Update B″ operation is determined as being a conflict because the original image B at the client 205 is associated with a transaction value that is equal Seq. 4 which is greater than the last synchronization anchor value of Seq. 3.

Within further exemplary embodiments for the detection of an Update/Delete conflict, instead of just comparing the target node N, it is also necessitated to compare the last modified transaction identifier on all the nodes in a sub-tree of N. If there is any node in the sub-tree which has a greater last modified transaction sequence number than the last synchronization anchor then a conflict is determined to exist.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method for using replication anchors to detect conflicts within replicated hierarchical content repository in a replication including multiple transactions, the method comprising:
locking a data object in the event that an operation applied on the data object is replicated from a first server to a second server, wherein the data object has been deleted in the second server;
reading, at the second server, a transaction identifier that is associated with the deleted data object;
retrieving, at the second server, a transaction sequence value that is associated with the transaction identifier; and
determining if a conflict situation exists by comparing the retrieved transaction sequence value with only an operation synchronization anchor value stored at the second server, the operation synchronization value being equal to the transaction sequence value of a last transaction of a replication including multiple transactions from the second server to the first server, wherein a conflict situation is determined to exist in the event that the transaction sequence value is greater than the operation synchronization anchor value.

2-6. (canceled)
